(19) United States
(12) Patent Application Publication
(10) Pub. No.: US 2026/0090568 A1
(43) Pub. Date: Apr. 2, 2026

(54) TEXTURED COMPOSITION COMPRISING PLANT PROTEINS AND HIGH AMYLOSE STARCH, METHOD FOR PREPARING SAME AND USE THEREOF

(71) Applicant: ROQUETTE FRERES, Lestrem (FR)

(72) Inventors: Carlos KANTT, North Aurora, IL (US); Chandani PERERA, Batavia, IL (US)

(21) Appl. No.: 19/114,679

(22) PCT Filed: Sep. 26, 2023
(86) PCT No.: PCT/EP2023/025409

§ 371 Date: Mar. 24, 2025

(30) Foreign Application Priority Data
Sep. 26, 2022 (EP) 22306421.3

(51) Int. Cl. A23J 3/26; A23J 3/14; A23J 3/22; A23L 23/00; A23L 29/212

(52) U.S. Cl. CPC A23J 3/26; A23J 3/14; A23J 3/227; A23L 23/00; A23L 29/212

(57) ABSTRACT

The invention relates to a composition comprising plant protein-rich material textured with high amylose starch, to a method for producing the same and to the use thereof.

The present invention relates to a specific textured composition comprising plant protein-rich material, preferably pea protein-rich material, and high amylose starch. The invention also relates to its method for the production thereof and to the use thereof.

The technique for texturing proteins, especially by extrusion cooking, with the aim of preparing products with a fibrous structure intended for producing meat and fish analogs, has been applied to numerous plant sources.

The extrusion cooking processes for proteins can be separated into two large families by the amount of water used in the process. When this amount is greater than 30% by weight, this will be referred to as “wet” extrusion cooking, and the products obtained will be more intended for producing finished products for immediate consumption that simulate animal meat, for example, beef steaks or chicken nuggets. For example, patent application WO 2014/081285 is known, which discloses a method for extruding a mixture of protein and fibers using a cooling die typical of wet extrusion. The present invention is in the field of dry extrusion.

When this amount of water is less than 30% by weight, this is then referred to as “dry” extrusion cooking: the products obtained are more intended to be used by food-processing manufacturers, in order to formulate meat substitutes by mixing them with other ingredients. The field of the present invention is that of “dry” extrusion cooking.

Historically, the first proteins used as meat analogs were extracted from soybean and wheat. Soybean subsequently quickly became the main source for this field of applications.

While most of the studies that followed obviously related to soybean proteins, other sources of protein, both animal and plant, have been textured: peanut, sesame, cottonseed, sunflower, corn, wheat proteins, proteins derived from microorganisms, by-products from abattoirs or the fisheries industry.

Leguminous proteins, such as those derived from pea and faba bean, have also been the subject of work, both in terms of the isolation thereof and in terms of the “dry” extrusion cooking thereof.

Numerous studies have been undertaken on leguminous and especially pea proteins given their particular functional and nutritional properties but also because of their non-genetically-modified nature.

Despite significant research efforts and increasing growth over recent years, the penetration of these products based on textured proteins on the food market is still subject to optimization.

One of the reasons particularly lies in the necessary process for rehydrating textured pea proteins before formulating them.

Indeed, since said proteins are dry, they must be rehydrated in order to be able to shape them and intimately mix them with other constituents of the formulation in order to obtain a satisfactory end result.

This rehydration often leads to a decrease in the organoleptic result as consumers found while consuming it a lack of firmness.

In order to overcome this problem, a potential solution involves decreasing the water holding capacity (WHC). Water holding capacity can be defined by the quantity of water that can be absorbed by a defined quantity of textured proteins in defined conditions. The more water absorbed, the less firm final product will be.

To reduce WHC, a main action is to rise density. While this solution works, it is not fully satisfactory as more water is needed in the process and/or more matter is needed for a same volume.

It is to the Applicant's credit that they have solved the above problems and have developed a new specific textured composition comprising plant proteins and high amylose starch, obtained by extrusion cooking in a dry process which allows a reduction of WHC while keeping density at same level.

As taught in “Textured vegetable proteins (TVP): Future foods standing on their merits as meat alternatives” (Baune & al., 2022), use of starch in this technical field is not obvious as “Increasing wheat starch concentrations decreased both, fibre structure as well as hardness and chewiness of the final products (Zhang et al., 2020b)”. The person skilled in the art would then not have selected starch in order to solve these problems.

This invention will be better understood in the following section which aims to disclose a general description thereof.

### GENERAL DESCRIPTION OF THE PRESENT INVENTION

The present invention relates to an extruded composition comprising plant protein-rich material and starch, said starch having an amylose content ranging from 50% to 90% by weight relative to the total weight of the starch.

Preferably, the plant protein-rich material are leguminous proteins excluding soy. Preferably, the leguminous protein is selected from the list made up of faba bean and pea. Pea is particularly preferred.

The protein content of the claimed composition ranges from 50% to 75%, preferably from 65% to 75% by dry weight relative to the total weight of dry matter of the composition.

Finally, percentage of the dry matter of the plant protein textured in a dry process according to the invention is more than 80% by weight relative to the total weight of the textured plant protein, preferably more than 90% by weight, preferably from 90% to 95%.

The present invention also relates to a method for producing an extruded composition of the invention described above, said method comprising the following steps:
1) providing a powder comprising plant protein-rich material and starch having amylose content ranging from 50% to 90% by weight relative to the total weight of the starch, said powder having a dry weight ratio of plant proteins to starch ranging from 70/30 to 90/10, preferably from 85/15 to 90/10;
2) extrusion cooking the powder with water, the water to powder mass ratio before cooking ranging from 1% to 40%, preferably from 10% to 30%, even more preferably from 15% to 25%;
3) cutting the extruded composition at the extruder outlet;
4) drying the extruded composition thus obtained.

Preferably, the plant protein-rich material are leguminous proteins. More preferably, the leguminous protein used in the method according to the invention is selected from the list comprising faba beans and peas, preferably a pea protein.

Preferably, the starch having amylose content ranging from 30% to 90% by weight relative to the total weight of the starch, is amylomaize starch.

Preferably, step 2 is carried out by extrusion cooking in a twin-screw extruder characterized by a length to diameter ratio ranging from 20 to 60, preferably from 30 to 50, preferably from 35 to 45, and equipped with 85-95% feeding elements, 2.5-10% kneading elements, and 2.5-10% reverse pitch elements.

Even more preferably, a specific mechanical energy ranging from 700 to 800 kj/kg is applied to the powder mixture during the extrusion cooking.

Even more preferably, the output of the twin-screw extruder is made up of an output die with holes with a diameter of 1.5 mm and with a knife, the speed of rotation of which ranges from 800 to 1,200 revolutions per minute, preferably from 900 to 1,100 revolutions per minute, preferably 1,000 revolutions per minute.

Finally, the present invention relates to the use of the composition of the invention as described above or obtained by the process described above in industrial applications such as, for example, the human and animal food industry, industrial pharmaceuticals or cosmetics.

Preferably, the industrial applications are selected in the list including meat analogs, fish analogs, inclusions for bakery.

The present invention will be better understood upon reading the following detailed description.

### DETAILED DESCRIPTION OF THE PRESENT INVENTION

The present invention relates to an extruded protein composition comprising plant protein-rich material and starch, said starch having an amylose content from 50% to 90% by weight relative to the total weight of the starch.

The plant protein-rich material is preferably a leguminous protein excluding soy, preferably selected from faba bean protein and pea protein. Pea protein is particularly preferred.

The term “leguminous” is considered herein to mean the family of dicotyledonous plants of the order Fabales. This is one of the largest flowering plant families, third after Orchidaceae and Asteraceae in terms of number of species. It contains approximately 765 genera, bringing together more than 19,500 species. Several leguminous plants are important crop plants, including soybean, beans, peas, faba beans, chickpeas, peanuts, cultivated lentils, cultivated alfalfa, various clovers, broad beans, carob and licorice.

The term “pea” is considered here in its broadest accepted use and includes in particular all the varieties of “smooth pea” and “wrinkled pea” and all the mutant varieties of “smooth pea” and “wrinkled pea”, regardless of the uses for which said varieties are usually intended (human food, animal feed and/or other uses).

The term “pea” in the present application includes pea varieties belonging to the Pisum genus and more specifically to the sativum and aestivum species. Said mutant varieties are in particular those called “mutants r”, “mutants rb”, “mutants rug 3”, “mutants rug 4”, “mutants rug 5” and “mutants lam” as described in the article by C-L HEYDLEY et al., entitled “Developing novel pea starches”, Proceedings of the Symposium of the Industrial Biochemistry and Biotechnology Group of the Biochemical Society, 1996, pp. 77-87.

If the leguminous proteins, in particular derived from faba beans and peas, are particularly adapted to the design of the invention, it is nevertheless possible to achieve the latter with other sources of plant proteins such as oat, mung bean, potato, corn or even chickpea protein. A person skilled in the art will know how to make any necessary adjustments.

“Starch” is understood to mean any compositions mainly comprising two polymers, amylose and amylopectin. Amylose is the fraction containing linear homopolymers of α-1,4-linked glucose and a few α-1,6 branch points. Amylopectin, on the other hand, is the branched fraction, consisting of linear α-1,4 glucose chains linked to other linear α-1,4 glucose chains by α-1,6 branch points.

Starch for the invention will be selected to have an amylose content comprised from 50% to 90% by weight based on total starch weight.

To be more precise, amylose content is selected from 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89% and 90% by weight relative to the total weight of the starch. Such values are commonly found in high amylose maize based starch which is then preferred. Commercial example of such starch is, for example, Eurylon 7 or N-400 produced by Roquette. Products obtained with such starch lead to a better organoleptic performance when consumed.

“Extruded”, “Textured” or “texturing” in the present application is understood to mean any physical and/or chemical process that aims at modifying a composition comprising proteins in order to give it a specific ordered structure. Within the scope of the invention, texturing proteins aims to give the appearance of a fiber, such as those present in animal meats. As will be described throughout the remainder of this description, a particularly preferred method for texturing proteins is extrusion cooking, particularly using a twin-screw extruder.

Preferably, the composition of the invention possesses a water holding capacity, measured by the following Test A, below 2.7; preferably below 2.5; preferably below 2.3; preferably below 2.2

In order to measure the water holding capacity, test A is used, the protocol of which is described below:
a. weighing a 20 g sample to be analyzed in a beaker;
b. adding drinking water at room temperature (temperature from 10° C. to 20° C., preferably 20° C.+/−1° C.) until the sample is completely submerged;
c. leaving in static contact for 30 minutes;
d. leaving to drain;
e. separating the residual water and the sample using a sieve;
f. weighing the final weight P of the rehydrated sample.

The computation for water holding capacity, expressed as grams of water per gram of protein analyzed, is as follows:

$$Water holding capacity = ( P - 20 ) / 20 .$$

“Drinking water” is understood to mean water that can be drunk or used for domestic and industrial purposes without posing health risks. Preferably, its conductivity is selected from 400 to 1,100, preferably from 400 to 600 μS/cm. More preferably in the present invention, it will be understood that this drinking water has a sulfate content of less than 250 mg/l, a chloride content of less than 200 mg/l, a potassium content of less than 12 mg/l, a pH ranging from 6.5 to 9 and a total hardness (TH, namely the hardness of the water, corresponding to the measurement of the calcium and magnesium ions content in water) of more than 15 French degrees. In other words, drinking water must not have less than 60 mg/l of calcium or 36 mg/l of magnesium.

Preferably, the composition of the invention possesses a bulk density, measured by the following Test B ranging from 90 g/L to 120 g/L; preferably from 100 g/L to 115 g/L; preferably from 105 g/L to 115 g/L

In order to measure the bulk density, test B is used, the protocol of which is described below:
a. taring a 2-liter graduated test tube;
b. filling the test tube with the product to be analyzed, until the 2-liter graduation is reached;
c. weighing the product (Weight P, in grams).

The computation of the bulk density expressed in g/I is as follows:

$$Bulk density = ( P ( g ) / 2 ) .$$

Finally, the dry matter content of the composition comprising plant protein-rich material textured in a dry process according to the invention is more than 80%, preferably more than 90%, more preferably from 90% to 95% by weight relative to the total weight of said composition.

The percentage of dry matter is measured using any method that is well known to a person skilled in the art. Preferably, the “desiccation” method is used. It involves determining the amount of water evaporated by heating a known amount of a sample of known mass. Heating is continued until the mass stabilizes, indicating that the water has evaporated completely. Preferably, the temperature used is 105° C.

The protein content of the composition according to the invention advantageously ranges from 50% to 75%, preferably from 65% to 75% by dry weight relative to the total weight of dry matter of the composition. Any method well known to a person skilled in the art can be used to analyze this protein content. Preferably, the total nitrogen amount will be assayed and this content will be multiplied by the coefficient 6.25. This method is particularly known and used for plant proteins.

The present invention also relates to a method for producing an extruded protein composition as described above, said method comprising the following steps:
1) providing a powder comprising plant protein-rich material, preferably leguminous proteins, preferably pea proteins and starch having amylose content comprised from 50% to 90% by weight relative to the total weight of the starch, said powder having a dry weight ratio of plant proteins to starch ranging from 70/30 to 90/10, preferably from 85/15 to 90/10;
2) extrusion cooking the powder with water, the water to powder mass ratio before cooking ranging from 10% to 30%, preferably from 12.5% to 25.5%, even more preferably from 15% to 20%;
3) drying the composition thus obtained.

Preferably, the plant protein-rich material of step 1 is selected from faba bean protein and pea protein. Pea protein is particularly preferred.

The powder comprising the plant protein-rich material and starch having amylose content comprised from 50% to 90% by weight relative to the total weight of the starch used in step 1 can be prepared by mixing said protein-rich material and starch. The powder can essentially consist of plant protein-rich material and starch having amylose content comprised from 50% to 90% by weight relative to the total weight of the starch. The term “essentially consist of” means that the powder can comprise impurities associated with the method for producing the protein-rich material and the starch, for example, traces of salt or oligosaccharides.

Preferably, the plant protein-rich material, preferably leguminous excluding soy, preferably pea proteins is characterized by a protein content advantageously ranging from 60% to 90%, preferably from 70% to 85%, even more preferably from 75% to 85% by dry weight relative to the total weight of dry matter of the plant protein-rich material. Any method well known to a person skilled in the art can be used to analyze this protein content. Preferably, the total nitrogen amount will be assayed and this content will be multiplied by the coefficient 6.25. This method is particularly known and used for plant proteins. Preferably, dry matter content of the plant protein-rich material is more than 80%, preferably more than 90% by weight relative to the total weight of said plant protein-rich material.

Even more preferably, the proteins are characterized by a particle size characterized by a Dmode ranging from 150 microns to 400 microns, preferably from 150 microns to 200 microns or from 350 microns to 450 microns. The measurement of this particle size is carried out using a MALVERN 3000 laser particle size analyzer in the dry phase (equipped with a powder module). The powder is placed in the feeder for the module with an opening ranging between 1 and 4 mm and a vibration frequency of 50% or 75%. The device automatically records the various sizes and adjusts the Particle Size Distribution (or PSD) as well as the Dmode, D10, D50 and D90. The Dmode is well known to a person skilled in the art and consists of the size of the largest population of particles.

The particle size of the powder is advantageous for the stability and the productivity of the method. An excessively fine particle size is irrevocably followed by problems that are sometimes difficult to manage during the extrusion method.

“Starch” is understood to mean any compositions mainly comprising two polymers, amylose and amylopectin. Amylose is the fraction containing linear homopolymers of α-1,4-linked glucose and a few α-1,6 branch points. Amylopectin, on the other hand, is the branched fraction, consisting of linear α-1,4 glucose chains linked to other linear α-1,4 glucose chains by α-1,6 branch points.

Starch for the invention will be selected to have an amylose content ranging from 50% to 90% by weight based on total starch weight.

To be more precise, amylose content is selected from 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89% and 90% by weight relative to the total weight of the starch. Such values are commonly found in high amylose maize based starch which is then preferred. Commercial example of such starch is, for example, Eurylon 7 or N-400 produced by Roquette. Products obtained with such starch lead to better organoleptic performance when consumed.

The mixing can be carried out upstream using a dry mixer or even directly as a feed from step 2. During this mixing, additives can be added that are well known to a person skilled in the art, such as flavorings or even dyes.

In an alternative embodiment, the starch/protein mixture is naturally obtained by turboseparation of a leguminous flour or other extraction/purification process. The plant seeds are cleaned, their outer fibers are removed, and they are ground to flour. The flour is then turboseparated, which consists in applying a rising stream of air, enabling the different particles to be separated based on their density.

During step 2, this mixture of powders will then be textured, which is the same as saying that the proteins and fibers will undergo thermal destructuring and reorganization in order to form fibers with continuous elongation in straight, parallel lines, simulating the fibers present in meats. Any method well known to a person skilled in the art will be suitable, in particular extrusion.

Extrusion consists in forcing a product to flow through a small hole, the die, under the action of high pressures and shearing forces, using the rotation of one or two Archimedes screws. The resulting heating causes cooking and/or denaturing of the product, hence the term sometimes used, “extrusion cooking”, then expansion by evaporation of the water at the die outlet. This technique makes it possible to develop products which are widely varied in their composition, their structure (expanded and alveolar form of the product), and their functional and nutritional properties (denaturing of anti-nutritional or toxic factors, sterilization of food, for example). Processing of proteins often leads to structural modifications which are reflected by obtaining products with a fibrous appearance, simulating animal meat fibers. Step 2 must be carried out with a water to powder mass ratio before cooking ranging from 10% to 30%, preferably from 12.5% to 25.5%, even more preferably from 15% to 20%. This ratio is obtained by dividing the amount of water by the amount of powder, and by multiplying by 100. Preferably, the water is injected at the end of the feeding zone and immediately before the kneading zone.

Without being bound by any theory, it is well known to a person skilled in the art of extrusion cooking that it is this ratio that will allow the required density to be obtained. The values of this ratio therefore will potentially be 10, 11, 12, 13, 14, 15, 16, 17, 18, 19, 20, 21, 22, 23, 24, 25, 26, 27, 28, 29 or 30%.

Any drinking water is suitable for this purpose. “Drinking water” is understood to mean water that can be drunk or used for domestic and industrial purposes without posing health risks. Preferably, its conductivity is selected from 400 to 1,100, preferably from 400 to 600 μS/cm. More preferably in the present invention, it will be understood that this drinking water has a sulfate content of less than 250 mg/l, a chloride content of less than 200 mg/l, a potassium content of less than 12 mg/l, a pH ranging from 6.5 to 9 and a total hardness (TH, namely the hardness of the water, corresponding to the measurement of the calcium and magnesium ions content in water) of more than 15 French degrees. In other words, drinking water must not have less than 60 mg/l of calcium or 36 mg/l of magnesium. This definition includes water from the drinking water network, decarbonated water, demineralized water.

Preferably, step 2 is carried out by extrusion cooking in a twin-screw extruder characterized by a length to diameter ratio ranging from 20 to 45, preferably from 35 to 45, preferably 40, and equipped with a series of 85-95% feeding elements, 2.5-10% kneading elements, and 2.5-10% reverse pitch elements.

The length to diameter ratio is a conventional parameter in extrusion cooking. This ratio therefore can be 20, 21, 22, 23, 24, 25, 26, 27, 28, 29, 30, 31, 32, 33, 34, 35, 36, 37, 38, 39, 40, 41, 42, 43, 44 or 45.

The various elements are the feeding elements intended for feeding the product into the die without modifying the product, the kneading elements intended for mixing the product and the reverse pitch elements intended for applying a force to the product to cause it to advance in the opposite direction and thus cause mixing and shearing.

Preferably, the feeding elements will be placed at the very beginning of the screw with a temperature set from 20° C. to 70° C., then the kneading elements and reverse pitch elements with a temperature ranging from 70° C. to 120° C.

Preferably, this screw is rotated from 900 to 1,200 revolutions/min, preferably from 1,000 to 1,100 revolutions/min.

Even more preferably, a specific power ranging from 700 to 800 kj/kg is applied to the powder mixture.

Step 3 then involves cutting the extruded composition at the extruder outlet made up of an outlet die with holes

Cutting can be done only by letting extruded protein exiting the die or also

In a preferred mode, die is fitted by hole with a diameter of 1.5 mm and equipped with a knife, the speed of rotation of which ranges from 1,200 to 1,800 revolutions per minute, or from 2,000 to 2,400 revolutions per minute, preferably around 1,500 revolutions/min.

The knife is placed flush with the outlet of the extruder, preferably at a distance ranging between 0 and 5 mm. “Flush” is understood to be at a distance extremely close to the die located at the outlet of the extruder, at the limit of touching the die but without touching it. Conventionally, a person skilled in the art will adjust this distance by making the knife and the die touch each other, then by shifting the latter very slightly.

The last step 4 involves drying the composition thus obtained.

A person skilled in the art will know how to use the appropriate technology in order to dry the composition according to the invention from the wide selection currently available to them. Without limitation and solely by way of an example, air flow dryers, microwave dryers, fluidized bed dryers or vacuum dryers can be cited. A person skilled in the art will select the correct parameters, mainly the time and temperature, in order to achieve the desired final percentage of dry matter. The final dry matter content of the final extruded composition is seeked to range from 80% to 100%, preferably from 85% to 100%, more preferably from 90% to 100%, or from 95% to 100%.

Finally, the present invention relates to the use of the composition of plant proteins textured in a dry process as described above in an industrial application such as, for example, the human and animal food industry products, industrial pharmaceuticals or cosmetics.

The human and animal food industry products are understood to mean industrial confectionery (for example, chocolate, caramel, jelly sweets), bakery products (for example, bread, brioches, muffins), the meat and fish substitutes industry (for example, sausages, hamburgers, fish nuggets, chicken nuggets), sauces substitutes (for example, bolognaise, mayonnaise), substitutes of products derived from milk (for example, cheese, plant milk), beverages (for example, high protein beverages, powdered beverages to be reconstituted).

More preferably, the present invention relates to the use of the composition of plant proteins textured in a dry process as described above in the field of baking.

The invention will be of particular interest in order to produce inclusions in bakery products such as muffins, cookies, cakes, bagels, pizza dough, breads and breakfast cereals.

The term “inclusions” is understood to mean particles (in this case the composition of plant proteins textured in a dry process) mixed with a dough before it is cooked. After this step, the composition of plant proteins textured in a dry process is trapped in the final product (hence the term “inclusion”) and provides both its protein content as well as crunchiness when consumed.

The invention will be of particular interest in order to produce inclusions in confectionery products such as fat filings, chocolates, so as to also provide protein retention as well as crunchiness.

The invention will be of particular interest in order to produce inclusions in products that are alternatives to dairy products such as cheeses, yogurts, ice creams and beverages.

The invention will be of particular interest in the field of analogs of meat, fish, sauces, soups.

A particular application relates to the use of the composition according to the invention for manufacturing meat substitutes, in particular minced meat, and also bolognaise sauce, steak for hamburgers, meat for tacos and pitta, “Chili sin carne”.

In pizzas, the composition comprising textured leguminous proteins according to the invention will be of particular interest for being sprinkled on top of said pizza (“topping”).

In dehydrated ready meals (for example, Bolino in Europe or Good Dot in India), the textured composition according to the invention will be used as an element providing fiber and protein. Thus, a product can be obtained that hydrates quickly and to its core, while being pleasing to chew.

The invention will be better understood upon reading the following non-limiting examples.

### EXAMPLES

### Example 1: Production of a Composition of Plant Proteins Textured in a Dry Process According to the Invention

Ingredients to be used:
Pea Protein: Nutralys® F85M
Pea fiber: 150M
Maize starch with high amylose content (more than 70% of amylose on total starch weight): N-400
Waxy maize starch with low amylose content (less than 15% of amylose on total starch weight): N-200
Maize Starch (Medium amylose content around 25%)
Pea starch N735 (between 30% and 50% amylose)
Modified starch: Clearam CH 2020 (less than 15% of amylose on total starch weight)
Modified starch: Clearam CH 3020 (less than 15% of amylose on total starch weight)
Modified starch: Clearam CH 4020 (less than 15% of amylose on total starch weight)
Modified starch: Clearam CJ 5025 (less than 15% of amylose on total starch weight)

In this study, textured pea protein (TPP) was produced using a standard dry feed mix that consists of 87% of pea protein (F85M) and 13% of pea fiber (I50M) as reference of common textured pea protein currently on the market. Trials below consisted in replacement of pea fiber by different types of starches.

Batch size of approximately 30 pounds was prepared beforehand for this trial run. All the weighed raw dry ingredients were mixed thoroughly in Hobart mixer for 10 min to achieve homogeneous blend. After applying proper setting or putting in the new feed for extruder approximately 15 minutes was given for an extruder to stabilize and give a consistent product output. Order of all runs were randomized to avoid the mechanical error. Once the extruder was stabilized samples were collected and kept in commercial dehydrator system for drying process.

Extruder used was a Coperion ZSK-25 with an L/D=40. The feed rate for all trial was kept constant at 13.5 kg/hr.

Three different categories of maize starches were used to understand and observe their effect on the water holding capacity (WHC) of the extruded textured pea protein (TPP). These 3 different categories used were maize starch rich in amylose (N400), amylopectin starch poor in amylose also known as waxy maize starch (N200) and lastly maize starch used as standard. High amylose starch had straight chain structure whereas, amylopectin starch had a branched structure. Standard samples of maize starch consist of 25% amylose and 75% amylopectin. Main component of all the sample remains same as control sample that was pea protein (F85M). Pea starch (N735) which possess amylose content between 30% and 50% was also tested.

Parameters for these trials are summarized in Table 1 below:

| | | | N200 | N400 | Standard | |
|---|---|---|---|---|---|---|
| | | Pea fiber | Starch | Starch | Starch | N735 |
| | | TVP | (low | (High | (medium | Pea |
| | | (reference) | amylose) | amylose) | amylose) | starch |
| Extrusion | Barrel #2 | 20 | 20 | 20 | 20 | 20 |
| parameters | temperature (° c.) | | | | | |
| | Barrel #3 | 30 | 30 | 30 | 30 | 30 |
| | temperature (° c.) | | | | | |
| | Barrel | 40 | 40 | 40 | 40 | 40 |
| | #4temperature (° c.) | | | | | |
| | Barrel #5 | 60 | 60 | 60 | 60 | 60 |
| | temperature (° c.) | | | | | |
| | Barrel #6 | 110 | 120 | 120 | 120 | 120 |
| | temperature (° c.) | | | | | |
| | Barrel #7 | 130 | 150 | 150 | 150 | 150 |
| | temperature (° c.) | | | | | |
| | Barrel #8 | 120 | 130 | 130 | 130 | 130 |
| | temperature (° c.) | | | | | |
| | Barrel | 95 | 95 | 95 | 95 | 95 |
| | #9temperature (° c.) | | | | | |
| | Production Temp | 128 | 140 | 129 | 130 | 132 |
| | (° C.) | | | | | |
| | Dry feed (g/min) | 225 | 225 | 225 | 225 | 225 |
| | Water feed (g/min) | 37.5 | 21 | 26.5 | 25 | 27.5 |
| | Hydration (Water | 16.7% | 9.3% | 11.8% | 11.1% | 12.2% |
| | feed/Dry feed) | | | | | |
| | screw speed RPM | 1050 | 1050 | 1050 | 1050 | 1050 |
| | Cutter speed RPM | 1000 | 1000 | 1000 | 1000 | 1000 |
| Measured | Pressure psi | 770 | 870 | 760 | 720 | 750 |
| paramteres | Torque % | 25 | 27 | 28 | 27 | 27 |
| | SME Kj/Kg | 1100.00 | 1267.68 | 1285.88 | 1247.40 | 1277.12 |

All parameters applied to process extrusion (Temperatures, dry feed, screw feed and cutter speed) are all at same levels. Only water feed has been lowered to obtain comparable extruded compositions at the output of extruder, especially in bulk density.

Next trials were focused to see the individual effect of different crosslinked starches. Gross-linked starched are those that undergo a molecular reaction at selected hydroxyl (—OH) groups of two adjoining intact starch molecule. The purpose of cross linking was to enable the starch to withstand such condition as low pH, high shear or high temperature. Starch used were Clearam OH 2020, Clearam OH 3020, Glearam OH 4020, and Glearam CJ 5025.

Parameters for these trials are summarized in Table 2 below:

| | | Pea fiber | CH 2020 | CH 3020 | CH 4020 | CJ 5025 |
|---|---|---|---|---|---|---|
| | | TVP | (modified | (modified | (modified | (modified |
| | | (reference) | starch) | starch) | starch) | starch) |
| Extrusion | Barrel #2 | 20 | 20 | 20 | 20 | 20 |
| parameters | temperature (° c.) | | | | | |
| | Barrel #3 | 30 | 30 | 30 | 30 | 30 |
| | temperature (° c.) | | | | | |
| | Barrel | 40 | 40 | 40 | 40 | 40 |
| | #4temperature (° c.) | | | | | |
| | Barrel #5 | 80 | 80 | 80 | 80 | 80 |
| | temperature (° c.) | | | | | |
| | Barrel #6 | 140 | 80 | 120 | 80 | 80 |
| | temperature (° c.) | | | | | |
| | Barrel #7 | 170 | 100 | 170 | 100 | 100 |
| | temperature (° c.) | | | | | |
| | Barrel #8 | 150 | 100 | 150 | 100 | 100 |
| | temperature (° c.) | | | | | |
| | Barrel | 120 | 90 | 110 | 90 | 90 |
| | #9temperature (° c.) | | | | | |
| | Production Temp ° C. | 129 | 143 | 138 | 140 | 146 |
| | Dry feed (g/min) | 225 | 245 | 225 | 233 | 267 |
| | Water feed (g/min) | 47 | 23.5 | 27.5 | 20.5 | 22 |
| | Hydration (Water | 20.9% | 9.6% | 12.2% | 8.8% | 8.2% |
| | feed/Dry feed) | | | | | |
| | screw speed RPM | 1000 | 1000 | 1000 | 1000 | 1000 |
| | Cutter speed RPM | 1000 | 1000 | 1000 | 1000 | 1000 |
| Measured | SME Kj/Kg | 849.3 | 1147.1 | 1002.0 | 1128.2 | 1179.9 |
| parameters | Pressure psi | 515 | 930 | 730 | 950 | 1030 |
| | Torque % | 21 | 28 | 23 | 26 | 31 |

All the collected samples were analysed for bulk density, water holding capacity and textural properties. Textural properties were analysed using a “TA. HD. plus texture analyser” with a flat probe (even surface) and 30 kg of force. Measured textural properties are Firmness (force required by machine to deform the sample to 75% strain), Resilience (measurement of how well product fights to regain its original shape and size), Instant spring back (how well a product physically springs back after it has been deformed during the first compression). To reduce the measurement error all the reading for textural properties were collected in triplicates and their average was used.

Results are summarized in Table below:

| | | Maize | | | | | | | |
|---|---|---|---|---|---|---|---|---|---|
| | Pea fiber | starch | | | | CH | CH | CH | CJ |
| Variation | (Reference) | (Standard) | N 200 | N400 | N735 | 2020 | 3020 | 4020 | 5025 |
| bulk Density | 95 | 101 | 85 | 109 | 102 | 84 | 120 | 84 | 57 |
| (g/L) | | | | | | | | | |
| Water holding | 3.83 | 2.88 | 2.71 | 2.17 | 2.89 | 2.92 | 3.10 | 3.09 | 3.06 |
| Capacity (g/g) | | | | | | | | | |
| Average | 5965 | 5062 | 5513 | 7243 | 5428 | 6244 | 5357 | 5255 | 6270 |
| Firmness (g) | | | | | | | | | |
| Resilience | 38.90 | 35.15 | 34.11 | 37.61 | 35.10 | 33.10 | 34.47 | 32.47 | 37.55 |
| Average (%) | | | | | | | | | |
| Spring back | 40.44 | 36.24 | 47.64 | 46.87 | 42.45 | 48.15 | 56.91 | 71.47 | 36.78 |
| Average (%) | | | | | | | | | |

It can be seen that only N400 which is a starch containing more than 70% of amylose can lead to a textured protein composition that have a WHO below 2.5 with density around 100 g/L. This composition has also the highest firmness of all trials. Even modified starches can't give WHC and firmness at these levels.

Trials have also been made with levels of starch ranging from 8% to 18%. Same conclusion, only high amylose starch (more than 50% amylose) can lead to to a textured protein composition that have a WHC below 2.5 with density around 100 g/L.

1. An extruded protein composition comprising plant protein-rich material and starch, said starch having an amylose content ranging from 50% to 90% by weight relative to the total weight of the starch.

2. The extruded protein composition according to claim 1, wherein the amylose content of the starch ranges from 50% to 90% by weight relative to the total weight of the starch, preferably selected from 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89% and 90% by weight relative to the total weight of the starch.

3. The extruded protein composition according to claim 1, wherein the plant protein-rich material is selected from leguminous proteins excluding soy, preferably selected from faba bean and pea, more preferably pea.

4. The extruded protein composition according to claim 1, having a protein content ranging from 50% to 75%, preferably from 65% to 75% by dry weight relative to the total weight of dry matter of the composition.

5. The extruded protein composition according to claim 1, having a dry matter content of more than 80%, preferably more than 90%, more preferably from 90% to 95% by weight relative to the total weight of said composition.

6. The extruded protein composition according to claim 1, wherein said composition possesses a water holding capacity, measured by the Test A, below 2.7; preferably below 2.5; preferably below 2.3; preferably below 2.2 and a bulk density, measured by the Test B ranging from 90 g/L and 120 g/L; preferably from 100 g/L to 115 g/L; more preferably from 105 g/L to 115 g/L.

7. A method for producing an extruded protein composition according to claim 1, the method comprising the following steps:
1) providing a powder comprising plant protein-rich material and starch having amylose content ranging from 50% to 90% by weight relative to the total weight of the starch, said powder having a dry weight ratio of proteins to starch ranging from 70/30 to 90/10, preferably from 85/15 to 90/10;
2) extrusion cooking the powder with water, the water to powder mass ratio before cooking ranging from 1% to 40%, preferably from 10% to 30%, even more preferably from 15% to 25%;
3) cutting the extruded composition at the extruder outlet;
4) drying the composition thus obtained.

8. The method according to claim 7, wherein the plant protein-rich material of step 1 is selected from leguminous plants excluding soy, preferably faba bean protein and pea protein, more preferably pea.

9. The method according to claim 7 wherein the plant protein-rich material is characterized by a protein content ranging from 60% to 90%, preferably from 70% to 85%, even more preferably from 75% to 85% by weight to the total dry matter.

10. (canceled)

11. (canceled)

12. The method according to claim 7 wherein amylose content of starch ranges from 50% to 90% by weight relative to the total weight of the starch, preferably selected between 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89% and 90% by weight relative to the total weight of the starch.

13. The method according to claim 7 wherein Step 2 is carried out with a water to powder mass ratio before cooking ranging from 10% to 30%, preferably from 12.5% to 25.5%, even more preferably from 15% to 20%.

14. (canceled)

15. (canceled)

16. (canceled)

17. (canceled)

18. The method according to claim 7, wherein Step 3 comprises cutting the extruded composition at the extruder outlet made up of an outlet die with holes.

19. (canceled)

20. (canceled)

21. (canceled)

22. Use of an extruded composition according to claim 1 or obtained in an industrial application, including food, feed, or specialized nutrition applications of said method comprising the following steps:
1) providing the powder comprising plant protein-rich material and starch having amylose content ranging from 50% to 90% by weight relative to the total weight of the starch, said powder having a dry weight ratio of proteins to starch ranging from 70/30 to 90/10, preferably from 85/15 to 90/10;
2) extrusion cooking the powder with water, the water to powder mass ratio before cooking ranging from 1% to 40%, preferably from 10% to 30%, even more preferably from 15% to 25%;
3) cutting the extruded composition at the extruder outlet;
4) drying the composition thus obtained.

23. The use according to claim 22 wherein the food application is chosen among meat substitutes, fish substitutes, sauces or soups, especially meat substitutes, in particular minced meat substitutes, and also bolognaise sauce substitutes, steak substitutes for hamburgers, meat substitutes for tacos and pitta, “Chili sin carne”.
